(19) United States
(12) Patent Application Publication
(10) Pub. No.: US 2005/0033658 A1
(43) Pub. Date: Feb. 10, 2005

(54) Print order reconfirmation system and a print order reconfirmation method

(75) Inventors: Shigeru Takeuchi, Tokyo (JP); Muneyoshi Matsunami, Tokyo (JP)

Correspondence Address: Finnegan, Henderson, Farabow,;Garrett & Dunner, L.L.P., 1300 I Street, N.W., Washington, DC, 20005-3315, US

(73) Assignee: KONICA MINOLTA PHOTO IMAGING, INC.

(21) Appl. No.: 10/910,365

(22) Filed: Aug. 4, 2004

(30) Foreign Application Priority Data
Aug. 8, 2003 (JP) JP2003-289945

(51) Int. Cl. G06F 17/60

(52) U.S. Cl. 705/26

(57) ABSTRACT

A print order reconfirmation system including orderers 2 such as school pupils, their approvers 5, a photographer 3 who takes pictures, a laboratory 4 who makes picture prints by the orders; wherein the laboratory 4 develops films, prepares sample pictures, and sends them together with print order forms to the orderers 2, the orderers 2 respectively select desired pictures and fill out the order forms, and the photographer 3 informs the persons 5 in parental authority on the orderers 2 of the order information such as unit prices, quantities, print sizes, and picture identifying information from its ordering terminal 3a before starting to print out and prints out after getting their express consents with this.

### BACKGROUND OF THE INVENTION

This invention relates to a print order reconfirmation system and a method thereof, particularly to a print order reconfirmation system and a method thereof for school-related pictures.

Usually, schools ask professional photographers to take pictures of various school events such as school trips, athletic meets, entrance ceremonies, graduation ceremonies, etc. to have good memorial pictures without fail. For example, a professional photographer joins a school event, takes snap shots and group pictures of all members in the school, develops sample pictures after the event, shows the sample pictures for demonstration, collects orders of desired pictures from school members, and asks the laboratory to print them in bulk.

Specifically, for example, a professional photographer prepares a sample picture panel or album of pictures of a school event for demonstration, and puts the sample picture panel on the school bulletin board or passes the sample album among school members. Each school member selects pictures he or she wants from the sample picture panel or album, and lists them in a print order form together with information that identifies the selected pictures and a person who places the order such as school name, event name, his/her name, date of order, picture numbers, quantities, and so on. The photographer collects print orders in classes or schools and sends them to the contracted print shop such as a laboratory. The print shop or the laboratory reads the print order forms, collects orders, prints pictures by the orders, classifies the finished prints by school members, puts them in individual print order envelopes, and sends them to respective school members.

There has been a method for using print order forms of the computer-scoring answer sheet type to quicken order collection and eliminate wrong order entries. For example, Japanese Non-examined Patent Publication H08-293009 (Pages 4 to 6 and FIG. 1) discloses print order forms of the computer-scoring answer sheet type for school print ordering each of which has at least two entry fields such as an order number entry field and a quantity field for entered order numbers.

In ordering pictures of school events, pupils themselves select pictures from a sample picture panel or album and determine their quantities, but the sums are usually charged to their parents (or persons who consent in parental authority). So it sometimes happens that the quantities of pictures that a pupil ordered exceeds what its parent permits.

This will rarely happen when the orderers are old enough (for example, high-school students or older). They will order as many pictures as they want and will rarely make a wrong order. Contrarily, orderers younger than high-school students (e.g. pupils in elementary schools) may order more pictures than they require just for amusement and write wrong order information by mistake. Therefore, an easy print ordering system to prevent such wrong print orders have been expected.

### SUMMARY OF THE INVENTION

This invention has been made to solve such problems and a main object of this invention is to provide a print order reconfirmation system and a print order reconfirmation method that can easily and reliably prevent useless printouts due to wrong print orders made by school pupils.

To accomplish the above object, a print order reconfirmation system of this invention comprises an input section from which a first customer enters print order information, a storage section for storing the print order information entered from the input section, and a sending section for sending the print order information from the storage section to a terminal of a second customer.

Further, the print order reconfirmation system of this invention comprises a receiving section for receiving print order information from a first customer, a storage section for storing the print order information that was received by the receiving section, and a sending section for sending the print order information from the storage section to a terminal of a second customer.

The print order reconfirmation system of this invention can contain an amount calculating section for calculating the amount of each order from the print order information that is entered by the input section or received by the receiving section. Further the storage section can be configured to store the print charge information calculated by the amount calculating section.

The system configuration of this invention can have a section for receiving information which determines whether the print order information from the second customer's terminal is approved or a means for receiving information which changes the content of the print order sent from the second customer's terminal.

In accordance with this invention, it is preferable that the print order information entered from the input section or received by the receiving section contains any of print price information, print quantity information, print size information and print-picture identifying information. Further, it is preferable that the print order information sent by the sending section any of print price information, print quantity information, print size information and print-picture identifying information.

Further, in accordance with this invention, it is preferable that the first customer is a minor under the age of 18 and the second customer is its parent or person in parental authority.

Furthermore, a method of approving a print order of this invention comprises a step of entering print order information of the first customer, a step of storing the entered print order information, and a step of sending the stored information to the second customer's terminal.

The method of approving a print order of this invention comprises a step of receiving print order information of the first customer, a step of storing the received print order information, and a step of sending the stored information to the second customer's terminal.

As explained above, when a pupil (a minor under the age of 18) makes an order of pictures of a school event, the print order reconfirmation system of this invention notifies its parent or person in parental authority of the print order information such as print price, print quantity, print size, and print-picture identifying information and processes the order only after getting its consent. The minors under the age of 18 cannot get printouts that they ordered without express permissions from their parents or persons in parental authority. This system can easily and reliably prevent useless printouts due to wrong print orders made by minors under the age of 18.

### BRIEF DESCRIPTION OF THE DRAWINGS

FIG. 1 shows the configuration of a print order reconfirmation system which is a first embodiment of this invention.

FIG. 2 shows the functional block diagram of an ordering terminal in accordance with the first embodiment of this invention.

FIG. 3 shows the operational flow of a print order reconfirmation procedure in accordance with the first embodiment of this invention.

FIG. 4 shows the configuration of a sample picture panel in accordance with the first embodiment of this invention.

FIG. 5 shows the item layout of a print order form in accordance with the first embodiment of this invention.

FIG. 6(a) shows the item layout of a print order form in accordance with the first embodiment of this invention.

FIG. 6(b) shows the layout of coded information labels in accordance with the first embodiment of this invention.

FIG. 7(a) shows the item layout of a sample picture panel in accordance with the first embodiment of this invention.

FIG. 7(b) shows the item layout of a print order envelope in accordance with the first embodiment of this invention.

FIG. 8(a) shows the item layout of a print order form in accordance with the first embodiment of this invention.

FIG. 8(b) shows the item layout of coded information labels in accordance with the first embodiment of this invention.

FIG. 9 shows the configuration of a print order reconfirmation system which is a second embodiment of this invention.

FIG. 10 shows the functional block diagram of an ordering terminal in accordance with the second embodiment of this invention.

FIG. 11 shows the operational flow of a print order reconfirmation procedure in accordance with the second embodiment of this invention.

FIG. 12 shows the configuration of a print order screen in accordance with the second embodiment of this invention.

### DETAILED DESCRIPTION OF PREFERRED EMBODIMENTS

A preferred embodiment of the print order reconfirmation system in accordance with this invention comprises orderers 2 such as school pupils, their approvers 5 (who consent in parental authority), a photographer 3 who joins school events and takes pictures, a laboratory 4 who makes picture prints by the orders; wherein the laboratory develops films, prepares panel-like or album-like sample pictures, and sends them together with print order forms to the orderers via the photographer, the orderers respectively select desired pictures and fill out the order forms, and the photographer or laboratory collects the order forms, informs the persons in parental authority on the orderers of the order information such as unit prices, quantities, print sizes, and picture identifying information before starting to print out and prints out only after getting their express consents. With this, this system can prevent wasteful printing by wrong print orders. Some embodiments will be described below in more detail with reference to the accompanying drawings.

[Embodiment 1]

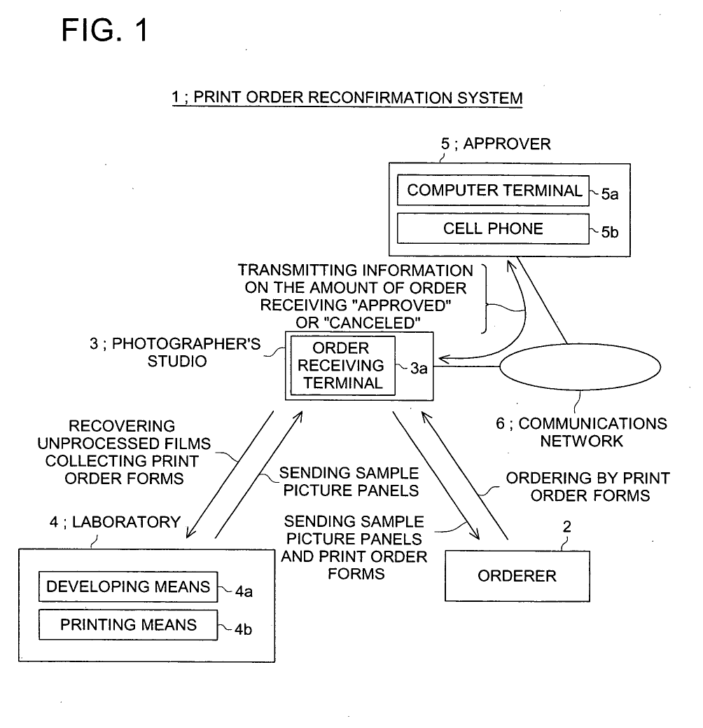

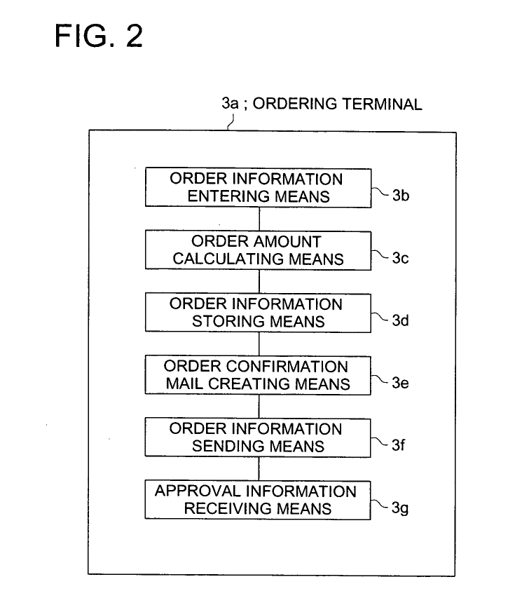

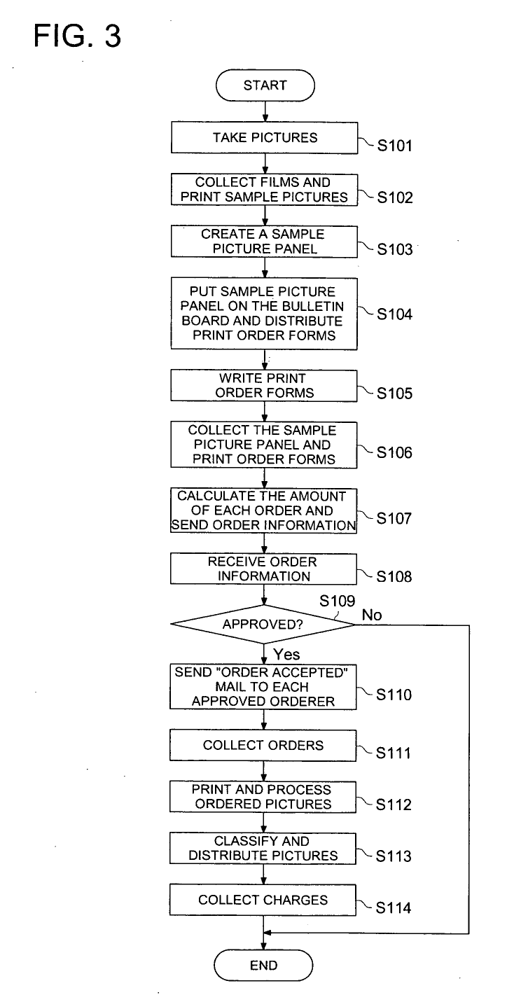

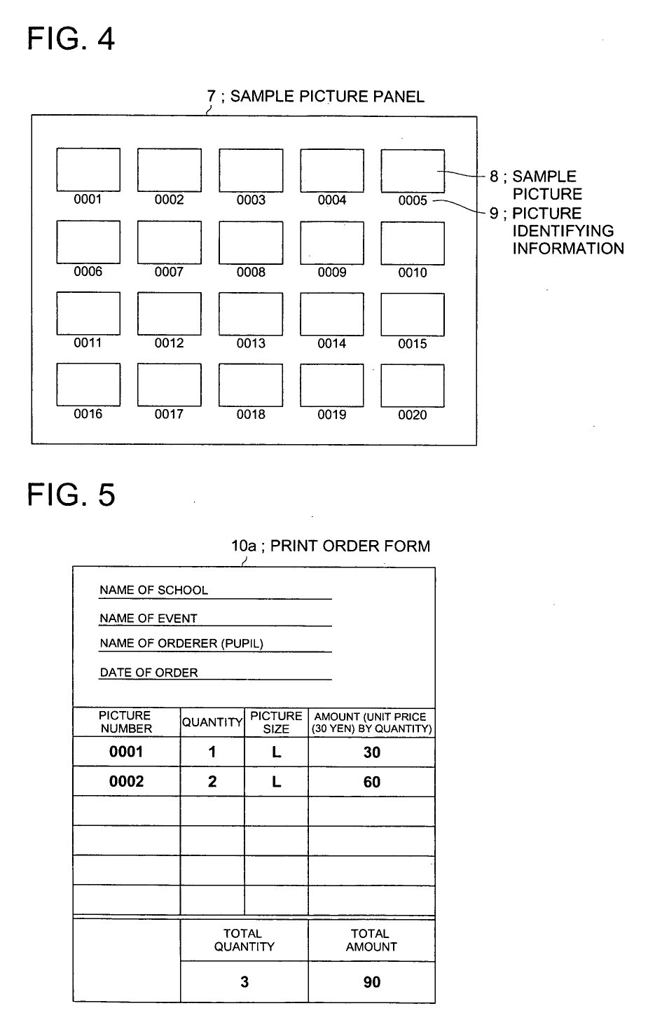

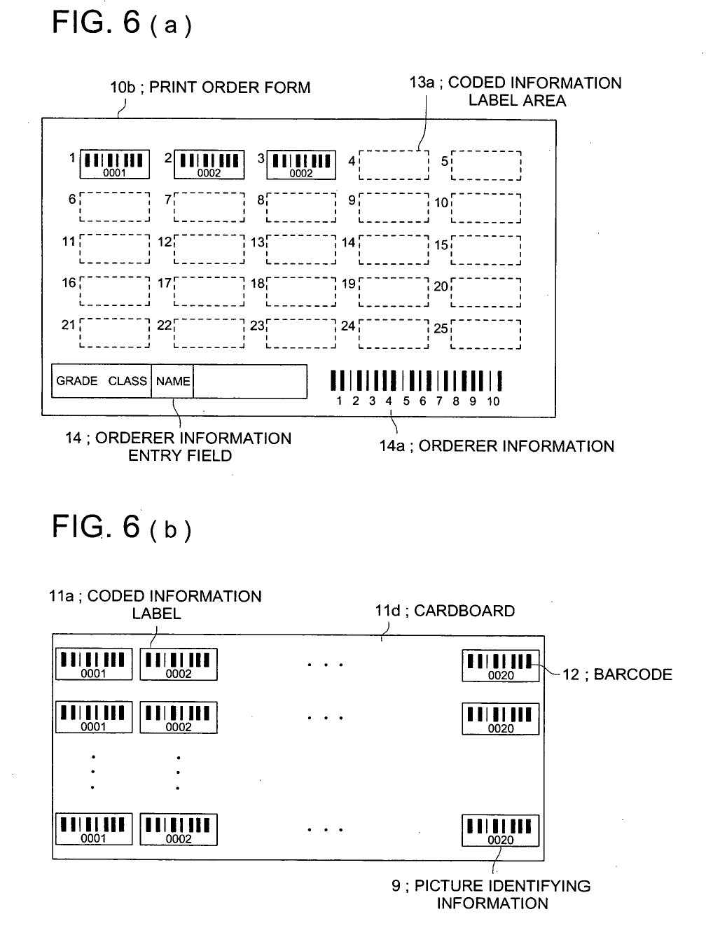

A print order reconfirmation system and a method thereof in accordance with the first embodiment of this invention will be explained below with reference to FIG. 1 to FIG. 8. FIG. 1 shows the configuration of a print order reconfirmation system which is the first embodiment of this invention. FIG. 2 shows the functional block diagram of an ordering terminal in the system. FIG. 3 shows the operational flow of a print ordering and reconfirming procedure of the system. FIG. 4 shows an example of demonstrating sample pictures on a bulletin board. FIG. 5 shows an example of item layout of a print order form. FIG. 6 to FIG. 8 respectively show examples of print order form, coded information labels, and sample picture panels for print ordering using coded information.

As shown in FIG. 1, the print order reconfirmation system 1 of this invention comprises a photographer 3 who joins a school event, takes pictures of the event, and receives print orders through an ordering terminal 3a, a laboratory 4 which collects exposed films, makes sample picture panels or albums of the event and makes copies of the pictures, orderers 2 such as school pupils who respectively select desired pictures from the sample picture panels or albums and fill out the order forms, and parents or persons 5 in parental authority of the pupils who receive order information of their pupils from the photographer 3 through respective computer terminals 5a or cell phones 5b, and approve or cancel the orders; wherein the photographer 3 and the parents or persons 5 in parental authority are interconnected through a communications network such as Internet. The laboratory 4 contains a developing section 4a for developing films and a printing section 4b for making printouts from the films.

As shown in FIG. 2, the ordering terminal 3a comprises an order information entering means 3b for entering order information, an order amount calculating means 3c for calculating the amount of order from print quantities, print sizes, and so on, an order information storing means 3d for storing order information such as the order amount, etc., an order confirmation mail creating means 3e for creating order confirmation mails to be sent to parents or persons 5 in parental authority, an order information sending means 3f for sending order confirmation mails, and an approval information receiving means 3g for receiving approval or cancellation information from the parents or persons 5.

In the description below, the photographer 3 and the parents or persons 5 in parental authority are arranged to transfer order information and approval or cancellation information between them. However, it is possible to interconnect the laboratory 4 and the parents or persons 5 in parental authority with a communication network 6 to exchange these pieces of information. Further, the photographer 3 who takes pictures and the laboratory 4 which prints out pictures are provided separately for the sake of simplicity of explanation, but they can be put together. For example, when a clerk in the laboratory 4 takes pictures or when the photographer 3 develops and prints out pictures, they need not be separated. Further, a print shop equipped with an ordering terminal 3a can take print orders.

Referring to FIG. 3, we will explain an operational flow of the print order reconfirmation system 1 between a step of requesting a photographer 3 to take pictures and a step of distributing the ordered prints to orderers 2.

First, a school makes a schedule of events such as school trips, athletic meets, entrance ceremonies, graduation ceremonies, etc. and notifies the professional photographer 3 of the schedule. At Step S101, the professional photographer 3 joins each event and takes snap shots and group pictures of all members in the school. It can be assumed that the print order reconfirmation system of this invention uses only pictures taken by the professional photographer 3, but it is also possible that the print order reconfirmation system uses pictures taken by school officials (such as pupils, teachers and parents that join the event).

At Step S102, the laboratory 4 collects the exposed films from the photographer 3, develops the films by a developing means 4a and prints out sample pictures in the order of shots by a printing means 4b. It is preferable to print out picture ID information to identify each picture on the back of each sample picture and print-related data such as color tone and density to make identical copies.

Although the above description assumes that pictures are taken by film cameras and developed by the laboratory 4, it can be that the photographer 3 takes pictures by digital cameras, records the digital picture data in a storage section or sends the digital picture data to the laboratory 4 through a communications network and that the laboratory 4 processes the received digital picture data into picture prints by a printing means 4b. Naturally, the photographer 3 can use both film and digital cameras.

At Step S103, the laboratory 4 prepares a sample picture panel by is laying out sample pictures on a demonstration sheet with picture ID information near each picture as shown in FIG. 4. This sample picture panel can contain picture information such as the school name, the event name, and shooting places, and so on. Sample picture sheets having roll-like prints 8 and/or a book-like sample picture albums can be used together with or substituted for the sample picture panel 7. The picture layout of the sample picture panel of FIG. 4 is provided for explanation only and the sample picture panel can have any picture lay out as long as sample pictures 8 are correctly related to the picture ID information. In other words, the layout of pictures, size, and disposition of the pictures can be any on the sample picture panel.

At Step S104, the laboratory 4 or photographer 3 offers the sample picture panel 7 and print order forms to the school. The school puts the sample picture panel 7 in a prominent place that the pupils can see easily and distributes a print order form and an order envelope to each pupil.

At Step S105, each pupil browses sample pictures 8 on the sample picture panel 7 and writes the order on the print order form. This print order form 10a has items laid out as shown in FIG. 5. This order form has an entry field in which a school name, an event name which was photographed, a pupil name, and the date of order are written and an entry field in which picture ID information 9, quantity, size, and amount of each ordered picture are written. Each pupil writes order information on this form for ordering. (The print order form of FIG. 5 assumes one L-size picture 0001 and two L-size pictures 0002 are ordered.) The item layout of the print order form 10a of FIG. 5 can be any as long as the form 10a has at least an orderer 2 entry field and an order information entry field (picture ID information, number of prints, etc.)

At Step S106, the photographer 3 collects written print order form 10a and the sample picture panel 7. At Step S107, the photographer 3 reads the order information from the collected print order forms 10a, enters order information into the ordering terminal 3a using the order information entering means 3b, calculates the amounts of prints from quantities (number of prints) or sizes of the prints by using the order amount calculating means 3c, and stores the result in the order information storing means 3d. Then the photographer 3 creates electronic mails (for order reconfirmation) each of which contains order information such as print amounts and order information such as quantities, sizes, and picture ID information by the order confirmation mail creating means 3e and sends the electronic mails to relevant orderers 2 by the order information sending means through the communications network 6. The above procedure assumes that the electronic mail address of each parent or person 5 in parental authority of the orderer is sent from the school to the photographer 3 in advance, but the address can be written in each print order form 10a. Besides the electronic mails, any method can be used to post order information to parents or persons 5 in parental authority of the orderers (approvers 5) as long as the order information can be understood. For example, it is possible to confirm the contents of orders on the photographer's web page or use facsimile or postcards to post the order information.

At Step S108, each approver 5 receives the electronic mail (for order reconfirmation) containing the order information by a computer terminal 5a or cell phone 5b connected to the communications network 6 and checks the content of the order. When approving the order at Step S109, the parent or person 5 in parental authority of the orderer returns an electronic mail (approval mail) indicating that the parent or person 5 approves the order. When disagreeing to the order, the parent or person 5 returns an electronic mail (disagreement mail) indicating that the parent or person 5 does not agree to the order if necessary and cancels or changes the order. Besides the electronic mails to notify of approval or cancellation information, any method can be used to enter the approval or cancellation information on the above web site or use facsimile, postcards, or telephone to post the information. Further, it is possible that the parent or person 5 not only approves or cancels the order information but also changes the content of the order for approval. In this case, the parent or person 5 can modify the order information and return it (modified order information mail) to the photographer 3 by e-mail.

At Step S111, the photographer 3 receives approval mails, cancellation mails, and modified mails by using the approval information receiving means 3g, collects information of the approved and changed orders, and sends the result to the laboratory 4. At Step S112, the laboratory 4 prints the collected number of prints of each picture by the printing means 4b according to the result of collection of orders. In printing, the print data written on the back of each sample picture 8 is used to make identical copies of each picture of the same tone and density. Further, when a particular request is made to add a memorial comment or one-point illustration to a picture(s), it is added according to the order information.

Then at Step S113, the laboratory 4 sorts and bags prints according to the contents of orders manually or by a dedicated sorting machine in the laboratory 4 and sends the bags directly to the orderers 2 directly or via the photographer 3. After receiving the bags, a school staff distributes the bags respectively to the pupils whose names are on the bags. At Step S114, the school collects the amounts of orders from the pupils and pays them to the photographer 3. With this, a series of print ordering procedure is completed. In the above description, the amounts of orders are collected after the prints are distributed to the pupils. However, the amounts of orders can be collected at any time after the approval mails are sent at Step S110.

As explained above, the print order reconfirmation system carries out printing of ordered pictures only after the approvers 5 (parents or persons 5 in parental authority of the orderers 2) approve the order information (unit print price, quantity, size, and picture ID information) instead of carrying out printing of ordered pictures directly by the orderers 2 (pupils, etc.). Therefore, this system can easily and reliably prevent useless printouts due to wrong print orders. Further, in this system, the approvers 5 can not only approve or cancel the order information but also modify the content of orders. Therefore, even when the order information is modified, this system can smoothly carry out printing of school event pictures by new order information.

The above explanation assumes that the print order forms 10a are manually written. These forms 10a must be read manually (e.g. by photographer staffers) to enter data in the ordering terminal 3a when the photographer 3 creates electronic mails for confirmation of order information and when the photographer 3 and the laboratory 4 collect order information. This work is troublesome and very time-consuming and apt to cause entry errors. To enter order information more efficiently without errors, the system 1 can be designed to encode and record picture identifying information, print quantities, print sizes, and orderer identifying information with bar codes or the like, and automatically read the encoded order information by a coded information reading means provided in the photographer 3 or laboratory 4.

This method will be described in further detail with reference to accompanying drawings. One method uses a print order form 10b and coded information labels 11a as shown in FIG. 6. In more detail, referring to FIG. 6(a), the print order form 10b contains a coded information label field 13a which shows positions of coded information labels to be automatically read by a coded information reading means and an orderer information entry field 14 which describes orderer information such as grade, class, and name. The print order form 10b can contain coded information (orderer information 14a) such as a school code assigned to each school and a pupil code assigned to each pupil.

Referring to FIG. 6(b), each coded information label 11a to be attached to the print order form 10b contains explicit and recognizable picture identifying information unique to each sample picture 8 and a bar code 12 of the picture identifying information. This information label 11a has adhesive on its backside so that it may be easily detached from the cardboard 11d and easily attached to the print order form 10b but hard to be removed from the print order form 10b.

For print ordering, the coded information labels 11a of the selected pictures are attached in sequence to the print order form 10b. For example, when you order one picture 0001 and two pictures 0002, attach one 0001 label and two 0002 labels 11a to the print order form.

Although the first method of FIG. 6 uses coded information labels 11a to the print order form 10b for print ordering, a second method provides a medium holder 16 to hold a plurality of media (coded information recording media 11b) each of which records encoded picture ID information 9 near each relevant picture 8 on the sample picture panel 7. An orderer 2 selects wanted pictures 8 on the sample picture panel 7, picks up their coded information recording medium 11b from their holders 16, and puts the media in the print order envelope 17 for direct picture ordering.

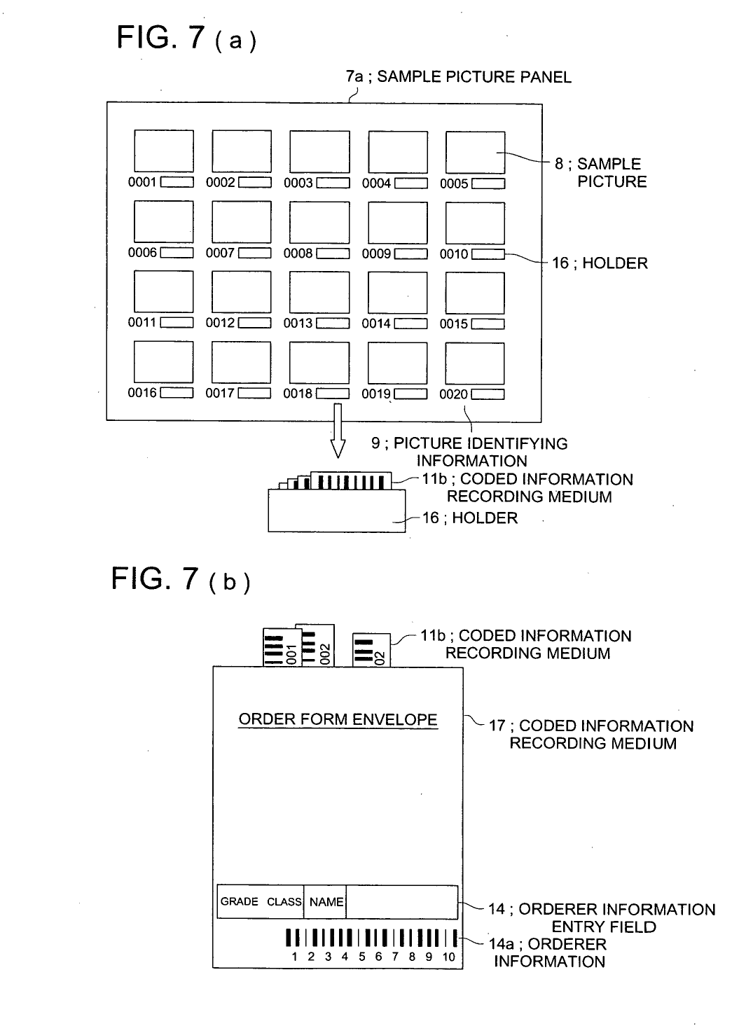

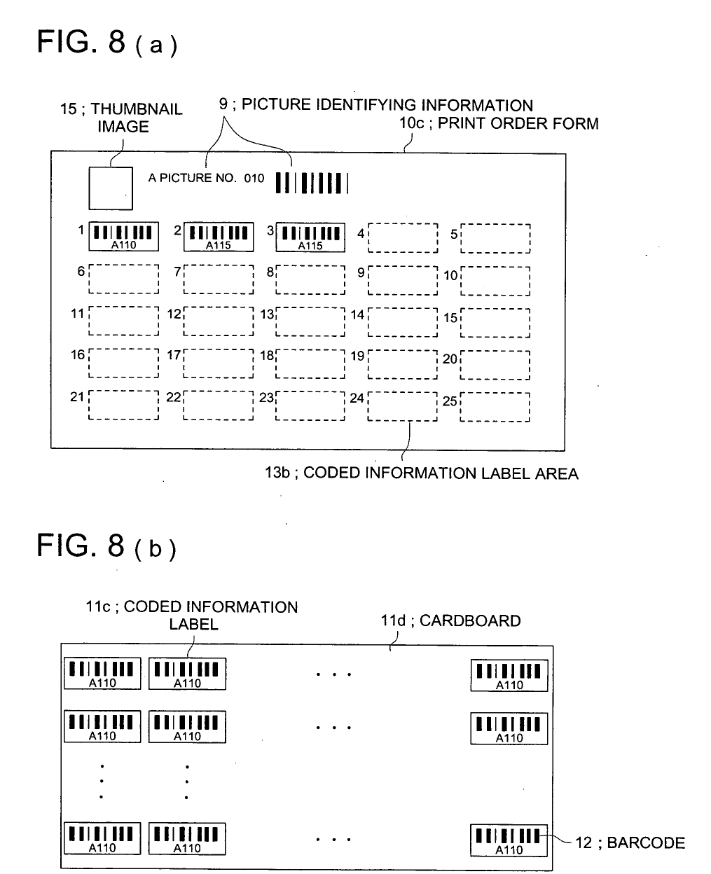

Although the second method of FIG. 6 or FIG. 7 uses coded picture identifying information 9, a third method can use coded orderer identifying information. In FIG. 8(a), for example, this method provides a print order form 10c for each sample picture 8. Each print order form 10c has a field for a thumbnail image 15 (a smaller copy of the picture), a field for picture identifying information 9, and a label attaching field 13b containing label attaching positions to which coded information labels are attached. In this case, each pupil is assigned a plurality of coded information labels 11 each of which explicitly shows information for identifying the pupil (orderer) 2 (e.g. information containing a school code “A” and a pupil code “110” in FIG. 8) and a barcode 12 which encodes the orderer identifying information.

The print order forms 10c prepared for each sample picture 8 are provided near the sample picture panel 7 or passed among the pupils. When wanting a print indicated by the thumbnail image (a smaller copy of sample picture 8) of a print order form 10c, a pupil attaches as many labels 11c of the pupil as wanted to the print order form 10c to order them. For example, when one pupil “A110” orders one copy of picture 0010 and another pupil “A115” orders two copies of picture 0010, the pupil “A110” attaches one of his coded information labels 11c to the print order form 10c of picture 0010 and the pupil “A115” attaches two of his labels 11c to this order form 10c as shown in FIG. 8(a).

To use such coded information, at Step S104, the laboratory 4 or photographer 3 provides the school with a prepared sample picture panel 7, print order forms 10b, and coded information labels 11a (sample picture panel 7a for the method of FIG. 7 or sample pictures 7, print order forms 10c, and coded information labels 11c for the method of FIG. 8). The school demonstrates the sample picture panel 7 (or 7a) in a prominent place that the pupils can see easily and distributes coded information labels 11a and 11c and coded information media 11b to each pupil.

At Step S105, each pupil browses sample pictures 8 on the sample picture panel 7, selects pictures to order, detach code information labels 11a containing information identifying the selected sample pictures 8 (or picks up the coded information media from their holders), attaches the labels sequentially to the print order form 10b (or puts the coded information media in the print order envelope 17) for print ordering or attaches the coded information labels 11c containing orderer identifying information to the print order forms of the selected sample pictures 8 for print ordering.

At Step S107, the photographer 3 reads order information from the coded information labels 11a, and 11c or coded information media 11b by the coded information reading means, stores it in the order information storing means 3d of the ordering terminal 3a, calculates the amounts of print orders from print quantities or print sizes by the order amount calculating means 3c, creates electronic mails (for reconfirmation of orders) describing print amounts and order information such as quantities, sizes, and picture ID information by the order confirmation mail creating means 3e, and sends the electronic mails to the parents or persons 5 in parental authority of the orderers 2 through the communications network 6 by the order information sending means 3f. At Step S111, the photographer 3 or laboratory 4 reads order information from the coded information labels 11a, and 11c or coded information media 11b of the approved or modified orders by the coded information reading means and collects order information.

The use of the coded information labels 11a, and 11c or coded information media 11b will make jobs to enter and collect order information easier and enable this embodiment to run effectively.

[Embodiment 2]

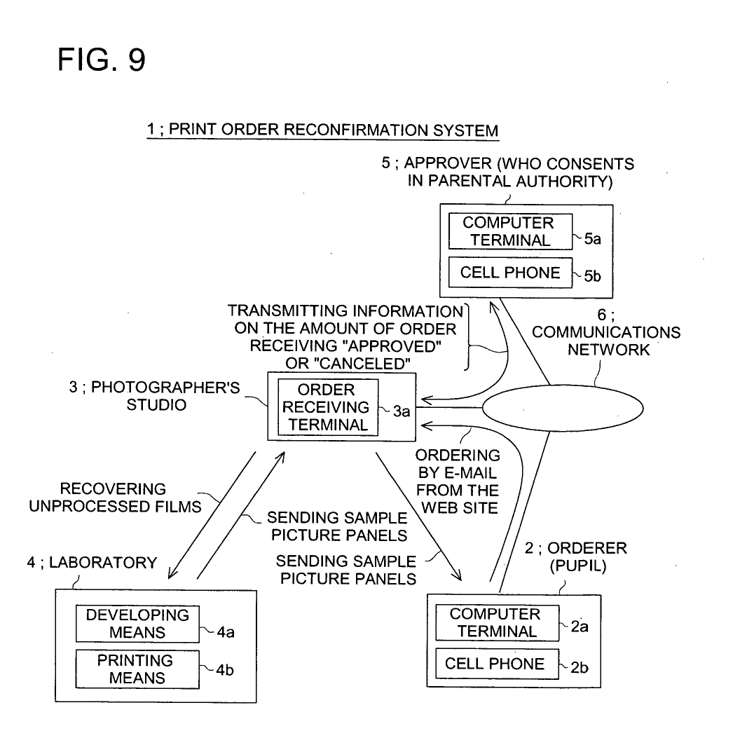

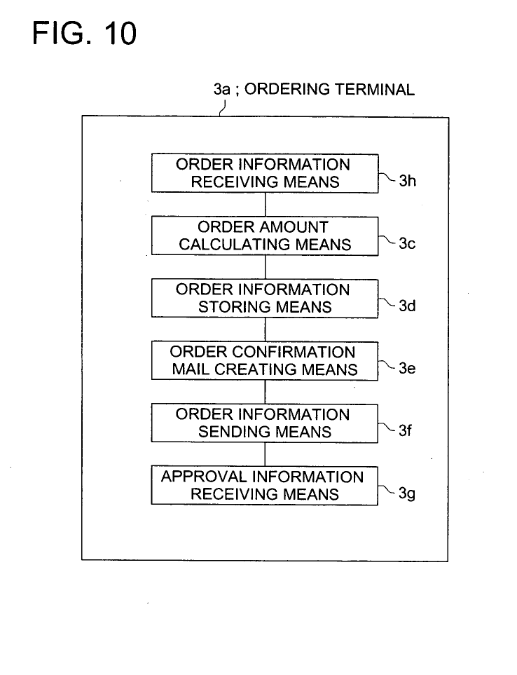

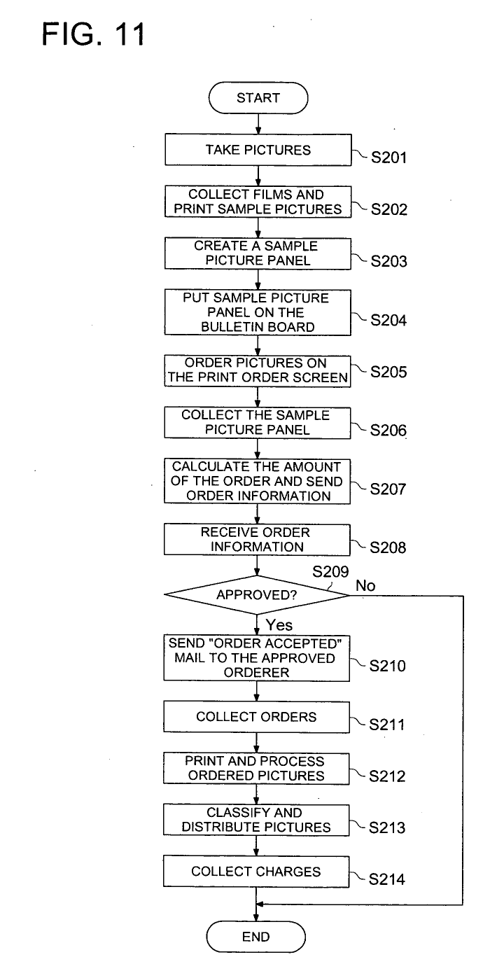

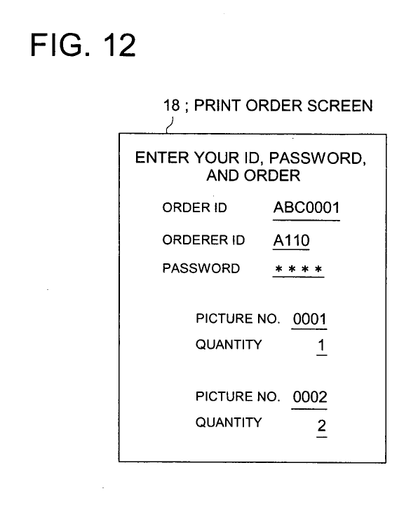

A print order reconfirmation system and a method thereof in accordance with the second embodiment of this invention will be explained below with reference to FIG. 9 to FIG. 12. FIG. 9 shows the schematic configuration of a print order reconfirmation system which is the second embodiment of this invention. FIG. 10 shows the functional block diagram of an ordering terminal in the system. FIG. 11 shows the operational flow of a print ordering and reconfirming procedure of the system. FIG. 12 shows an example of layout of the print order screen. This embodiment assumes that an orderer places a print order on a computer terminal or cell phone screen.

As shown in FIG. 9, the print order reconfirmation system 1 of this embodiment comprises a photographer 3 who joins a school event, takes pictures of the event, and receives print orders through an ordering terminal 3a, a laboratory 4 which collects exposed films, prints out sample pictures of the event, makes sample picture panels or albums, and makes copies of the pictures, orderers 2 such as school pupils each of which selects desired pictures from the sample picture panels or albums and places a print order by entering order information on a print order screen of its computer terminal 2a or cell phone 2b, and approvers 5 such as parents or persons in parental authority of the pupils who receive order information of their pupils from the photographer 3 through respective computer terminals 5a or cell phones 5b, and approve or cancel the orders; wherein the photographer 3, the orderers, and the approvers 5 are interconnected through a communications network 6 such as Internet.

The ordering terminal 3a comprises an order information receiving means 3b for receiving order information from computer terminals 2a or cell phones 2b of orderers 2, an order amount calculating means 3c for calculating the amount of order from print quantities, print sizes, and so on, an order information storing means 3d for storing order information such as the order amount, etc., an order confirmation mail creating means 3e for creating order confirmation mails to be sent to approvers 5, an order information sending means 3f for sending order confirmation mails, and an approval information receiving means 3g for receiving approval or cancellation information from the approvers 5.

Referring to FIG. 11, we will explain an operational flow of the print order reconfirmation system 1 between a step of requesting a photographer 3 to take pictures and a step of distributing the ordered prints to orderers 2.

Similarly to the first embodiment, at Step S201, the professional photographer 3 joins each event such as school trip, athletic meet, entrance ceremony, graduation ceremony, and takes snap shots and group pictures of all members in the school. At Step S202, the laboratory 4 collects exposed films from the photographer 3, develops them by a developing means 4a, and prints out sample pictures in the order of shots by the printing means 4b.

Next, at Step S203, the photographer 3 prepares a sample picture panel by putting sample pictures in order on a demonstration board and writing picture ID information (that is written on the backside of each sample picture) near each sample picture on the board. At Step S204, the laboratory 4 or photographer 3 provides the school with a prepared sample picture panel 7. The school demonstrates the sample picture panel 7 in a prominent place that the pupils can see easily and assigns information required for print ordering such as a unique order ID for identifying an order, a unique orderer ID for identifying an orderer 2, and password to each pupil.

At Step S205, each pupil browses sample pictures 8 on the sample picture panel 7, selects pictures to order, accesses a predetermined web site through a computer terminal 2a or cell phone 2b, view the print order screen, and enters order information on the screen. FIG. 12 shows an example of print order screen 18 on a cell phone 2b. This screen consists of an entry field for an order ID, an orderer ID, and a password, and an order entry field to enter sets of picture ID information 9 of each picture and the number of copies of the picture. The orderer first enters the order ID, the orderer ID, and the given password. When authenticated by the system, the orderer then enters order information such as picture ID information (picture number in FIG. 12) and the number of picture copies that are needed. For example, when you order one picture of picture number 0001 and two pictures of picture number 0002, you enter as shown in FIG. 12. Although the above explanation assumes that the orderer accesses a web site of the photographer 3 and enters order information on its print order screen 18, it is also possible to write the order ID, the orderer ID, and order information in a preset data format and send the data as an e-mail to a preset address.

Then, at Step S206, the photographer 3 gets back the sample picture panel 7. At Step S207, the photographer 3 reads order information from the print order screen 18 (or from the received order e-mails) by the order information receiving means 3h, calculates print prices from print quantities or print sizes by the order amount calculating means 3c, and stores the result in the order information storing means 3d. Then the photographer 3 creates e-mails (for order reconfirmation) writing the print prices and order information such as print quantities, print sizes, and print ID information by the order confirmation mail creating means 3e, and sends the e-mails to the approvers 5 of the relevant orderers 2 through the communications network 6 by the order information sending means 3f. As well as the first embodiment, the method of notifying the approvers 5 of the order information need not be by e-mails. It can be any as long as the order information can be read on a photographer's web site or by facsimile or postcards.

At Step S208, each approver 5 receives an e-mail (for order reconfirmation) writing the order information by a computer terminal 5a or cell phone 5b connected to the communications network 6 and checks the content of the order. At Step S209, when approving the order, the approver 5 returns an e-mail (approved mail) indicating that the approver 5 approves the order. When disagreeing to the order, the approver 5 returns an e-mail indicating that the approver 5 does not approve the order to the photographer 3 and cancels the order or waits for re-ordering. Similarly to the first embodiment, besides the electronic mails to notify of approval or cancellation information, any method can be used to enter the approval or cancellation information on the above web site or use facsimile, postcards, or telephone to post the information. Further, it is possible that the approver 5 sends a modification e-mail (modified mail) to modify the order.

Then at Step S211, the photographer 3 receives approved mails, cancelled mails, and/or modified mails by the approval information receiving means 3g, collects order information of approved and modified orders only, and sends the result to the laboratory 4. At Step S212, the laboratory 4 prints copies of ordered pictures of the ordered quantities according to the collected order information by the printing means 4b. Then at Step S213, the laboratory 4 bags prints for respective orders manually or by the sorting means in the laboratory 4 and delivers them directly to the orderers or through the photographer 3. The school distributes print bags to respective pupils, collects print amounts from pupils, and pays the sum amount to the photographer 3. With this, the series of print ordering procedure is complete.

As explained above, the print order reconfirmation system and the method thereof in accordance with this invention enables the orderers 2 to enter the order information on the print order screens 18 of the computer terminals 2a or cell phones 2b instead of writing the order information in the print order forms and to enter the order information in a preset data format and send the data as an e-mail to a preset address. This simplifies ordering works of the orderers and frees the photographer 3 and the laboratory 4 from entering order information again in the ordering terminal 3a. Therefore, the print order reconfirmation system can smoothly accomplish print formation of school event pictures.

Although respective embodiments assume that the orderers 2 are school pupils and the approvers 5 are parents or persons 5 in parental authority of the pupils, this invention is not limited to these embodiments. This system can also be applied to any system that validates orders when persons other than the orderers 2 approve the orders. Further, the above embodiments are respectively applied to orders of prints of school event pictures, but can be applied to any form that customers use pictures taken by professional photographers.

The print order reconfirmation system and the method thereof can easily and reliably prevent useless printouts due to wrong print orders made even by minors under the age of 18.

This is because print orders are not processed immediately after the pupils or the like writ order information in print order forms or on the print order screen and because the order information is sent to the parents or persons in parental authority of the pupils and print orders are processed only after the parents or persons approve the orders.

1. A print order reconfirmation system comprising;
a photography section to take the photograph of a customer's event by photography contractor,
a sample photograph creation section to create the sample photograph of the taken photography,
a selection section to select a print order photograph from the sample photograph by a first customer,
an input section to input the print order information on the print order,
a storage section to store the inputted print order information,
a print order information sending section to send the print order information from the storage section to a terminal of a second customer,
a terminal of the second customer, comprising;
an print order information receiving section to receive the print order information at the terminal of the second customer,
a approval information sending section to send the approval information on whether the print order is
approved from the terminal of the second customer to a photograph print section, and,
a photograph print section to receive the approval information on the print order, and to print the selected photograph.

2. The print order reconfirmation system of claim 1, further comprising;
a print amount calculating section to calculate the print amount of each order from the print order information that is entered by the input section.

3. The print order reconfirmation system of claim 2, wherein the storage section to store the print charge information calculated by the print amount calculating section.

4. The print order reconfirmation system of claim 1, wherein the print order information includes at least one of print price information, print quantity information, print size information and print-picture identifying information.

5. A print order reconfirmation method comprising steps of;
taking the photograph of a customer's event by photography contractor,
creating the sample photograph of the taken photography,
selecting a print order photograph from the sample photograph by a first customer,
inputting section to input the print order information on the print order,
storing the inputted print order information,
sending the print order information from the storage section to a terminal of a second customer,
receiving the print order information at the terminal of the second customer,
sending the approval information on whether the print order is approved from the terminal of the second customer to a photograph print section,
receiving the approval information on the print order, and
printing the selected photograph.

6. The print order reconfirmation method of claim 5, further comprising step of;
calculating the print amount of each order from the print order information that is entered by the inputting step.

7. The print order reconfirmation method of claim 6, wherein the storing step the print charge information calculated by the calculating step.

8. The print order reconfirmation method of claim 5, wherein the print order information includes at least one of print price information, print quantity information, print size information and print-picture identifying information.
